(19) United States
(12) Patent Application Publication
(10) Pub. No.: US 2025/0207460 A1
(43) Pub. Date: Jun. 26, 2025

(54) Light deflection systems with mirror reflection lenses

(71) Applicant: Helmut Köster, Frankfurt am Main (DE)

(72) Inventor: Helmut Köster, Frankfurt am Main (DE)

(21) Appl. No.: 18/852,451

(22) PCT Filed: Mar. 28, 2023
(86) PCT No.: PCT/IB2023/000110

§ 371 Date: Sep. 28, 2024

(30) Foreign Application Priority Data
Mar. 28, 2022 (DE) 10 2022 203 040.0
May 31, 2022 (DE) 10 2022 001 907.8

(51) Int. Cl. E06B 9/386; E06B 9/24

(52) U.S. Cl. CPC E06B 9/386; E06B 2009/2417; E06B 2009/247; E06B 2009/2476

(57) ABSTRACT

The invention relates to a light deflection system with mirror reflection optics for deflecting light radiation. The slat system consists of a statically load-bearing slat body, wherein the slat body 10, 63, 40, 105 accommodates at least two individual reflector strips on its upper side 31, 32, 33, 34, 52, 53, 64, 65, 103 to 105). At least one reflector strip 31, 33, 64 has at least one toothed, light-reflecting upper side and at least one reflector strip 32, 34, 64 has a smooth and/or stepped, light-reflecting upper side, which is characterised by the reflector strip 31, 33, 64 with a serrated contour can deflect light in the direction of the incidence of light A and the reflector strip 32, 34, 65 with a smooth and/or stepped contour can deflect light into a half-space I opposite the incidence of light. When the reflector strips are arranged in parallel, a bifocal optical system is created with a focus on the side of light incidence A and a focus on an opposite side I of the lens body.

The invention relates to light deflection systems with mirror reflection optics for deflecting sunlight.

Daylight deflection louvres with bifocal mirror optics are known in order to achieve different directions of reflection for incident solar radiation. See W/O 2017/134118A1, W/O 2020/225266A1, WO 2014/09449A1 and RETROLux type O and type U louvres from RETROSolar.

All known light directing louvres with bifocal optics are characterised by the fact that the contour of the stepped optics simultaneously provides static stability and the louvres are stiffened to prevent bending. Optics and statics are interrelated.

The state of the art is further characterised by the fact that a first stepped section of the slats (hereinafter referred to as retro-reflector) deflects the solar radiation impinging on it back into the sky as a result of a tooth-shaped contour and a second, flatter section (hereinafter referred to as light deflecting section), which directs the incident radiation inwards, whereby both sections are formed into their specific contour from a single wide strip by means of roll forming and the two sections, firmly connected to each other, form a coherent whole in the form of slats.

The state of the art includes slats with tooth-shaped folds of at least 3-4 mm long tooth flanks or max. 3-4 teeth in the retro-reflective section. With the known methods of sheet metal processing in slat production, it is not possible to produce, for example, 80 mm wide and very slim slats that necessarily have a large number of small teeth in the retro-reflective section in order to realise a minimum construction height h of the slats. However, this is desirable in order to achieve good transparency and increased diffuse light penetration between the slats, i.e. improved visual comfort.

The reason for this technical impossibility is that lamellae produced using the roll forming process require at least one roll groove for each tooth formation, which means that disproportionately large machines are required with correspondingly high tool costs. But even if the tooth-shaped cross-sectional contour of many teeth is introduced in large systems, stresses arise in the slat material between the tooth-shaped retroreflector and the flat light deflection section due to stretching differences in the slat cross-section over the length of the slats, which lead to unavoidable twisting (corkscrew effects) or even edge waviness of the slats, which can no longer be corrected in a subsequent roll forming process.

Another disadvantage of the fixed connections of the two sections in the prior art is the need to provide separate forming tools as well as cutting and perforating tools in the case of variants.

For different latitudes with different sun elevation angles, the teeth of the retroreflectors are moulded differently in order to adapt the appearance of the slats to the irradiation conditions. This also requires completely new tool sets.

For example, it is also desired to exchange the retroreflector and the light deflection section with each other, e.g. in order to deflect zenith light into the interior in the skylight area of a venetian blind for better room illumination. This requires completely new tool sets if the two sections are firmly connected to each other.

There is also the suggestion of rotating the slats by 180° so that the light deflection section captures zenith light. The problem, however, is that the slats no longer interlock into a slat packet. This observation leads to a further requirement: despite different optics, a formfitting slat package of the lower and upper slats in a hanging should be possible.

The invention has therefore set itself the task of developing slats that enable a large number of bifocal optics without special forming tools. The task is also to be able to produce very slim slats with very small, miniaturised tooth formations. It should also be possible to stack slats with different reflector systems within a blind.

The solution to the tasks is in accordance with main claim 1 and provides for a statically effective slat body which can accommodate at least two reflectors with variable optics which, however, have no static but only optical functions. The advantage of this separation between static and reflective optics is that the louvre body can be given a uniform design and different reflective optics can be installed depending on requirements. Another advantage is that the reflector strips from different manufacturing processes, each optimised or adapted to the design, can be combined on the body. For example, the slat body itself can be made of aluminium or plastic, the retro-reflector can be made of a foil printed with micro-teeth and metallised and the light deflection section can be made of a thin sheet.

The term ‘specular reflection’ refers to surfaces with a metallic lustre with directional or slightly scattered reflection, i.e. smooth or rougher surfaces.

The idea of the innovation is to produce the slats and their mirror optics from kits—i.e. to develop a slat body for variable reflectors and optics, whereby the slat body is designed independently of the type of light control and the requirements for beam guidance and is made up of three system components: the slat body and the light control system, consisting of at least one retro-reflector and one light control section. The system variants result from the specific combinations of reflector strips in a parallel arrangement and their curvature and tilting position in relation to each other. The innovative idea is to offer louvre bodies that allow many degrees of freedom in the design of the light control systems.

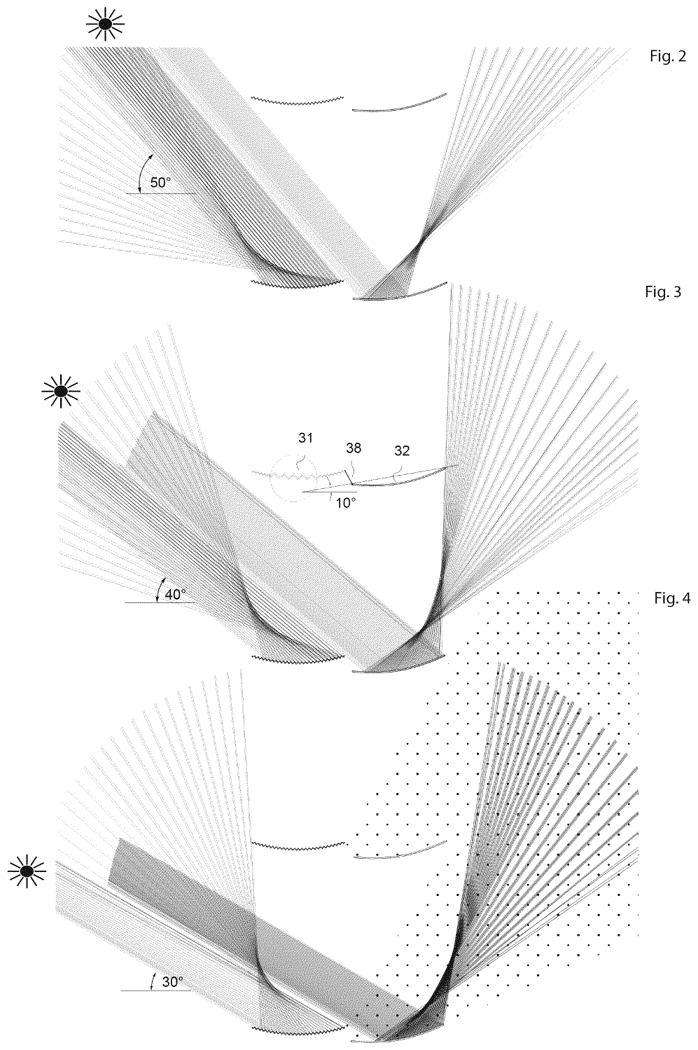

This new concept for the production of variable light deflection systems makes it possible, for example, to produce optics as shown in FIGS. 2-4, 5-7, 8, 10 or optics as shown in FIGS. 12 and 13 without changing the slat body itself and without special tool sets for moulding the complete slats.

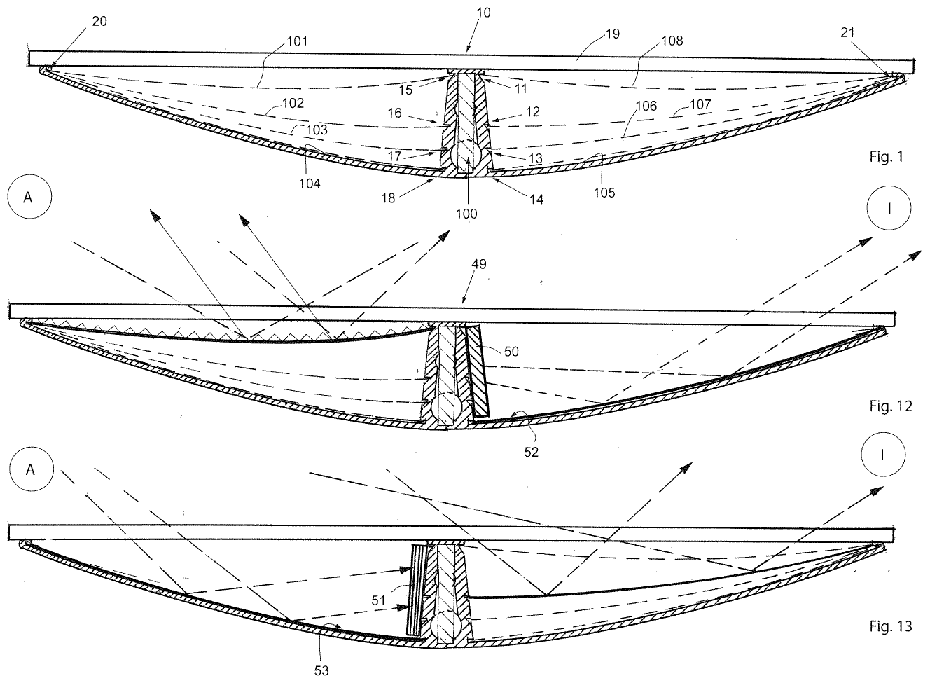

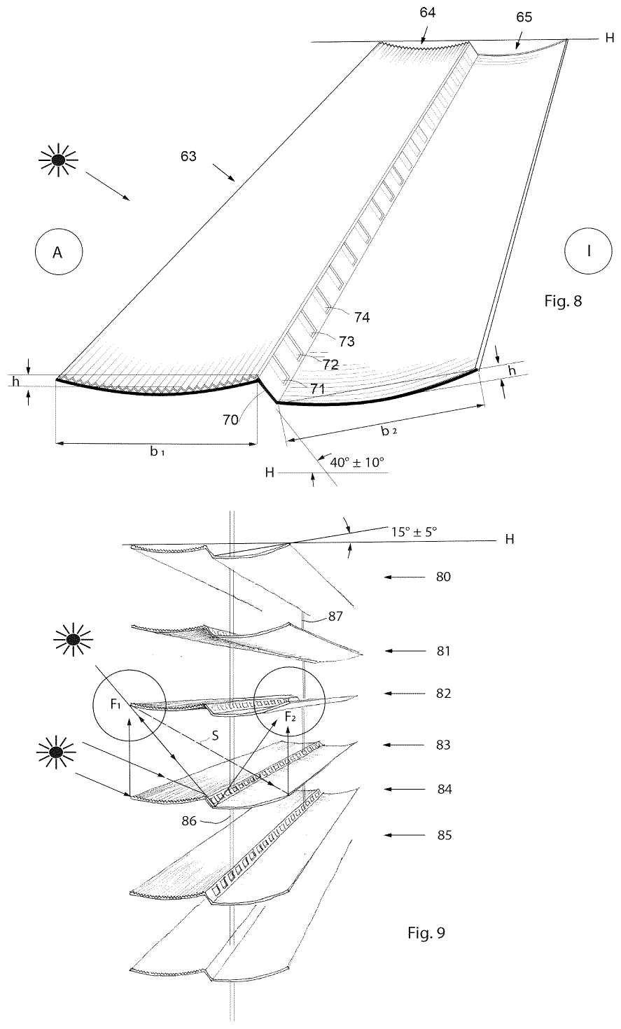

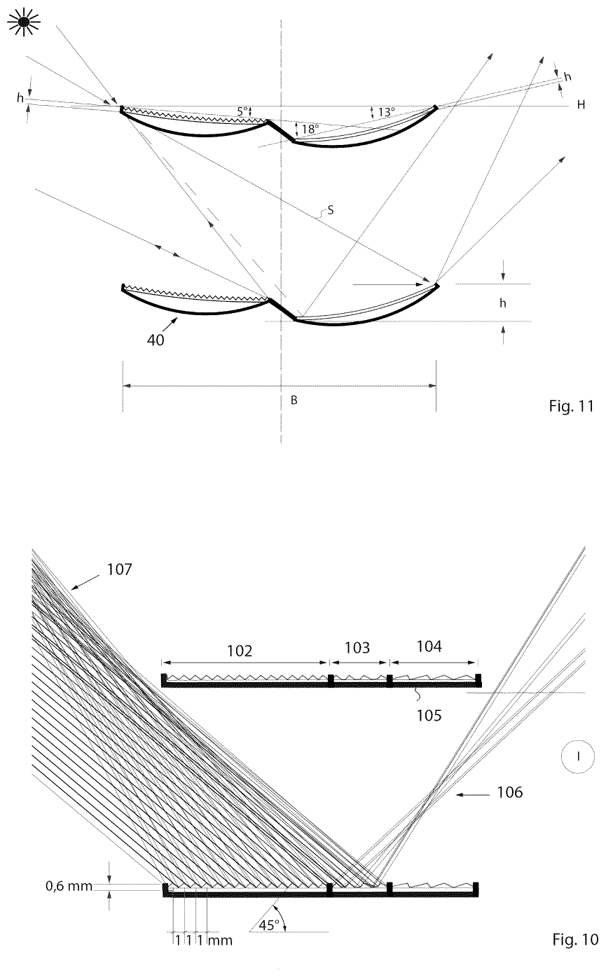

The slat body itself can be freely shaped according to static and/or design requirements. A typical example of a slat body is shown in FIGS. 8 and 11. FIG. 1 shows a larger slat body that can even accommodate the reflector strips in different installation positions or tilting angles. FIG. 8 shows a Z-shaped plastic slat body to which the reflector strips are either fed by co-extrusion and firmly joined to it, or the slat body in FIG. 11 has upstands into which the reflector strips are clamped. The same applies to a flat louvre as shown in FIG. 10.

The individual reflector strips themselves can be made from a thin strip or from foils, which can be produced in any width in in-house processes or online and later cut to the desired slit width. The process also offers the possibility of printing film strips with tooth structures using UV-curing lacquers, mirroring them and laminating them to the slat body. The tooth-shaped retroreflectors shown in the figures are enlarged to make the reflections clearer. In the case of printing films with tooth structures, the individual teeth have a size of e.g. hundredths of a millimetre, enabling the slimmest slats with the lowest construction height h, which only develops from the statics of the slat body.

The innovation of equipping a slat body with different optics from different manufacturing processes to create variable light control systems not only enables the reflector strips to be varied in fulfilment of the objective, but also the tilt angles of the reflector strips in the slat body (FIG. 1) in order to fulfil a wide range of lighting requirements. This innovation makes it easier to realise a wide range of light control requirements without having to constantly invest in new tools.

Further advantages are explained in the figures. They show:

FIG. 1 the cross-section through a slat body to accommodate two parallel reflector strips in variable installation positions

FIGS. 2 to 7 two parallel reflector strips and their reflective optics

FIG. 8 an extruded slat with a coextruded layer of a toothed and a smooth reflector

FIG. 9 section through a venetian blind

FIG. 10 section through a flat slat with three reflective strips

FIG. 11 an extruded plastic slat with pressed-in reflector strip

FIG. 12 the cross-section through a slat body to accommodate reflector strips and to integrate an LED strip light

FIG. 13 the cross-section through a slat body to accommodate reflector strips with integration of photovoltaics

In the following, the slat body for holding reflector strips with different reflective properties to form a large slat is referred to as a hollow slat housing (FIG. 1) or a shell housing (FIGS. 8, 10, 11), depending on the design, and variations of producible light guiding systems are described.

FIG. 1 shows a cross-section of a slat body in the form of a hollow slat housing. This consists of a centre bar 10, which has V-shaped grooves 11-18 on its outer sides, into which the reflector strips engage and give it a firm seat in a desired position in the body. There is a further V-shaped groove 20, 21 on the outer edges of the body. A flat strip is inserted into the groove 20, 21 and then snapped into the desired groove 11-18 in order to realise specific optical properties, including through the angular inclination of the reflector strips. The contour of the reflector strips is used to define the foci and thus the light distribution to the interior or exterior. Tilting the reflector strips towards the centre of the device at angles of 0° to 15° or more is useful, for example, to reduce glare from the light emitted by the slat body if the device is arranged below eye level. A more strongly tilted reflector strip deflects the reflection more steeply towards the interior ceiling in order to avoid glare in the eye of the observer of the slat body. Possible

positions 101 to 108 are shown as dashed lines. A decisive advantage of this design is also the aesthetics in the architectural façade: the slat body always retains its identical view in the façade and position, regardless of the design and inclination of the reflectors. The variations in appearance result from the tilted installation of the reflector strips. If the carcasses are arranged on the outside in front of the façade, they are covered with a disc 19. However, a tilted position of the body can be useful to allow rainwater to run off. The tilt angle of the reflector strips can be adjusted accordingly.

The central bar 10 for holding the reflector strips is designed as a hollow body and is used to hold a flat steel for stabilisation and/or, in the case of projection over the front edge of the body, for support in a supporting structure. The innovation also includes louvre bodies with several bars for holding 3 or 4 reflector strips.

FIGS. 2-7 show purely by way of example some typical optics or light control systems that can be realised with the hollow louvre housing from FIG. 1 or with a shell housing based on FIGS. 8 and 11.

FIGS. 2-4 show typical system combinations for a solar incidence of 30°, 40° and 50°, which are realised by installing the reflector strips 31, 32. The reflector strip 31 facing the sun's incidence has a retroreflective louvre optic, which is created by the tooth structure of the surface. The focus is formed on the side facing the sun, so that incident solar radiation is reflected back outwards to protect against overheating. The positioning of a focus of reflected radiation is determined by the type of concave bulge. The serrated structure of the flat strip in the figures is a regular structure of identical grooves at least on the upper side of the louvres, which only form a kind of Fresnel mirror for side light due to the concave shape of the louvre strips. The parallel louvre strip 32 is a smooth reflector, which likewise only has a focus towards the interior—i.e. on the side opposite to the incidence of sunlight—due to the concave shape. Due to the inclination of the louvre strip 32, the light can be deflected steeply towards the interior ceiling at an angle of approx. 10°. The angular inclination of 10° of the reflector strip is achieved, for example, when the slat engages in the grooves 21 and 13 in FIG. 1. The idea of the invention is to create the specific mirror optics by installing the slat strips in the slat body.

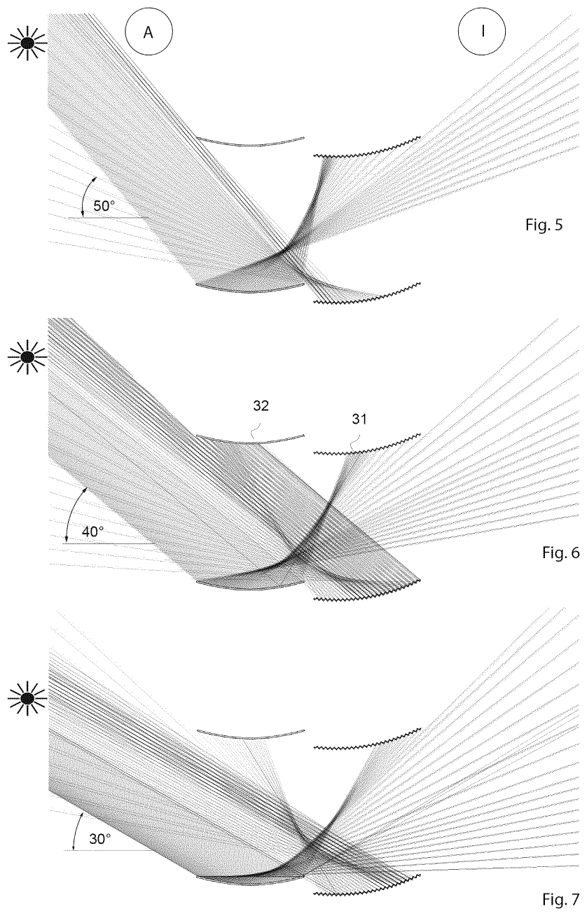

FIGS. 5-7 show an alternative light deflection system of the same design, whereby the toothed, retroreflective reflector strip 34 engages in the grooves 21 and 11 or 12 in FIG. 1 and the light deflection reflector engages in the grooves 20 and 15 or 19 and 17. This type of design is used for upper window areas for obtaining zenith light in the interior depth. The position of the foci is determined by the strip width, which results in a defined, concave bend in the cross-section. A comparable light directing system is possible if the toothed retroreflector in FIG. 8 or 11 is replaced by the light directing reflector and vice versa.

The slat body in FIG. 1 is highly innovative in that it is possible to create a wide variety of optical mirror systems with a sun protection function and lighting effect for the interior I and to create specific room lighting scenarios in the simplest possible way by simply clamping flat strips in grooves 11-18, and glare-free in adaptation to the eye height of the interior user according to the invention, even without separate roll-forming tools to create the complex geometries and contours as in the state of the art. Flat reflector strips can always be used for all variants of optical mirror systems. The reflector strips only need to be split in the strip width in order to form a concave shape in the clamping position.

A further idea for illuminating the room in FIGS. 1 and 12 is to integrate an LED strip 50 into the device and supplement the fading daylight with artificial light 39, 40 in FIG. 4. The LED strip 50 sits on the bar in the middle of the fixture and uses the concave mirror 52 to guide the light into the depth of the room as shown in FIG. 12. This enables perfect integration of artificial light and daylight. The slats with LEDs are arranged above the eye level of the viewer, allowing the LEDs to radiate freely towards the interior without causing glare. According to the invention, the LED strip is concealed in the housing of the louvre body without glare.

A further option in FIGS. 1 and 13 is to arrange photovoltaic cells 51 on the side of the central bar facing the outer space A. These receive direct sunlight as well as light reflected by the reflectors 53. The reflector 53 thus serves as a light concentration system.

To improve the efficiency of the photocells, in FIG. 1 the cavity 100 in the web 10 can either be filled with a liquid to dissipate the heat in the profile more quickly or a pipe with a cooling liquid flowing through it is drawn with a dashed line. In this way, the web or the lamella housing can also be used as a thermal solar collector.

By incorporating the reflector strips, the innovative slat body enables multifunctional use as a light control system to protect against the sun and overheating, for targeted room depth illumination, for integrating artificial light and daylight and as a solar collector for generating electricity or hot water.

However, the inventive idea is not limited to a slat body in the form of a hollow housing as shown in FIG. 1, which can accommodate different angular inclinations of the reflector strips. The innovation also relates to a lamella body in the form of a shell housing in FIG. 8 or a flat lamella in FIG. 11, on which the light-directing smooth or toothed, retro-reflective reflector strips can be placed and which enable variable optics as shown in FIGS. 2 to 7. The slat body is extruded from plastic or aluminum, for example, and either has exactly the desired contour to which the applied reflector strips 31, 32, 35, 36 adapt or the slat body is provided with an upstand for clamping the reflector strips. The advantage of clamping is that the curvature and therefore the appearance can be adapted to requirements simply by varying the width of the strips. Such a slat body is shown in FIG. 11.

The reflector strips can be fed to the louvre housing in a co-extrusion process and firmly connected to it. The innovation does not preclude the flat reflector strips from being preformed concave/convex online prior to a co-extrusion process when they are joined to the slat body. The reflective upper sides for beam guidance could also be convex. The undersides of the devices could also be partially or completely covered with metallic lamella strips.

A special design of the slat body in the form of a shell-shaped composite slat is shown in FIG. 8. Punched holes 71-74 and others can be made in series in the web 70 between the reflectors in order to guide a lift band or a lift cord through them later. The punched holes are in the shadow of the slat half orientated towards the incidence of light and therefore cannot cause glare in the interior. However, they improve the view of the blinds onto the street level. The perforations can either be wider for lift hinges or narrower for lift cords. Providing the slats with a regular punching offers the possibility of manufacturing them as bars with a high degree of prefabrication, whereby the lift cords can be drawn in at any point according to static requirements. The slats are supplied stacked in excess lengths, e.g. 6-7 metres. The slat stacks are then cut to the required slat length and can be inserted into ladder cords without further processing in the blind production process.

It would not be possible to produce the z-shaped slats with the serrated reflector from a single wide metal strip according to the state of the art. In contrast, the application of different lamella strips on a z-shaped extruded structure by means of clamping (FIG. 11) or gluing (FIGS. 8 and 10) is feasible without any problems. The different reflector strips can also be interchanged in order to capture zenithal light in the skylight area of a window, as demonstrated in FIGS. 2-4 and 5-6. FIG. 12 shows a slat body 40 that allows reflector strips of different widths to be inserted so that the radii or the bend and thus the position of the focal points can be varied.

Regardless of whether the device is a hollow or shell housing—the core idea of the innovative device is to create many different optical mirror systems with just two slat strips in order to adapt the daylight technology to different requirements such as the direction of the sky, latitude and room depths as well as to reduce glare for the interior user and to enable optimum transparency between the slats by means of a single, flat slat body.

FIG. 9 shows a perspective view of several slats arranged one below the other, which look identical but can fulfil differentiated lighting requirements—as already explained—due to the specific surfaces of the slat strips. The uniform view of the devices—regardless of their appearance—from the inside and from the street is an advantageous design feature of the innovation for use in architecture. The slats can also be interlocked to form a raised slat packet despite the different optics.

The slats 80 to 85 are penetrated by lift cords 86, 87 or lift tapes in the area of the punched holes.

FIG. 10 shows a flat slat body fitted with three reflector strips 102 to 104. Here, the light deflection section 104 is also toothed to enable the flat design. Section 102 and section 103 as well as section 104 are individual strips from completely separate manufacturing processes.

In the case of aluminium, the mirror finish of the foil strips is created by a bright anodised layer, for example. Alternatively, steel strips can be used with an electrolytically applied tin layer, for example. Other alternatives are the use of metallically vapour-coated foils or papers.

From an ecological point of view, a particular advantage of the development is that very thin strip material made of steel or aluminium of only 0.1 mm or thinner or films or paper printed with microstructures can be used for the reflectors, as the stability is ensured by the lamella body itself, e.g. made of plastic or aluminium.

All devices are advantageously matt white or coloured on their underside. In order to achieve a more precise beam guidance of radiation impinging on the underside, the undersides can also be reflective or at least metallically reflective, i.e. also matt reflective, also equipped with reflector strips.

All representations with ray tracing show an idealised contour with sharp tooth peaks and valleys. In reality, there are roundings with light scattering defects. The tooth structure is moulded into metal strips either in an embossing process, e.g. roll embossing with an embossed structure on the upper side and a smooth counter-pressure roll, or by moulding the teeth between two tooth-shaped rolls. The focal width of the Fresnel optics can be adjusted to the width of the lamellae by the concave moulding. This applies in particular to groove structures printed on films, which are produced and vapour-deposited in large widths of over 1 m and later cut to the exact width of the lamella. The innovation thus offers an extreme simplification of the otherwise complex contour formation of the retroreflection and the bifocal optics.

1. Light deflection system with mirror reflection optics for deflecting light radiation, characterised in that
the slat system consists of a statically load-bearing slat body, wherein
the slat body (10, 63, 40, 105) accommodates at least two individual reflector strips on its upper side (31, 32, 33, 34, 52, 53, 64, 65, 103 to 105), wherein
at least one reflector strip (31, 33, 64) has at least one serrated, light-reflecting upper side and
at least one reflector strip (32, 34, 64) has a smooth and/or stepped, light-reflecting upper side and that
the reflector strip (31, 33, 64) with a serrated contour deflects light in the direction of incidence (A) and
the reflector strip (32, 34, 65) with a smooth and/or stepped contour enables light to be deflected into a half-space (I) opposite the incidence of light, so that
parallel arrangement of the reflector strips produces a bifocal optical system with a focus on the side of the light incidence (A) and a focus on an opposite side (I) of the louvre body.

2. Light deflection system according to claim 1, characterised in that the stepped reflector with serrated contour is installed on a side (I) oriented towards the outer space (A) or on a side oriented towards the inner space (I) and the smooth and/or stepped contour is installed on a side of the louvre body oriented towards the outer space (A) or on a side oriented towards the inner space (I).

3. Light guiding system according to claim 1, characterised in that the initial width of the reflector strips (31, 32, 33, 34) is selected in such a way that the strength of the cross-sectional bending of the reflector strips (31, 32, 33, 34) and thus the focusing properties of the reflector strips can be determined by the edge pressure when the edges engage in grooves (11 to 17).

4. Light guiding system according to claim 1 or 2, characterised in that the slat body (10) has a central web (49) with grooves (11 to 13 and 15 to 17) offset in height and in that the reflector strips engage between grooves (20, 21) on the edges of the body and in one of the grooves offset in height and can thus be installed at different inclinations.

5. Light deflection system according to claims 1 and 3, characterised in that photovoltaic cells (50) are installed on a side of a web (49) facing the light irradiation, which photovoltaic cells can be exposed to reflected light radiation by means of a reflector strip (53) inclined towards the photovoltaic cell.

6. Light deflection system according to claim 4, characterised in that LED strips (50) are installed on a side facing away from the light beam, and the light radiation emitted by the LEDs can be deflected out of the slat body by means of a reflector piece (52) inclined towards the LEDs.

7. Light guiding system according to claim 1, characterised in that the lamella body is designed as a stable housing shell (40, 63) which serves as a blind lamella and in that two parallel, concave reflector strips are built into the lamella body, the reflector strips being arranged tilted relative to one another and being firmly connected to one another by an inclined central web (70) of the lamella body, wherein a plurality of slat steering bodies are held at a distance above one another and at a distance from one another in ladder or loop cords and furthermore punched holes (71 to 74 and others) can be introduced into the device, preferably into the web (70) between the grooves (64, 65), so that when the device is installed in a venetian blind, lift cords or lift tapes (87) can be passed through these punched holes (71 to 74).

8. Light guiding system according to claim 1, characterised in that the stepped reflector strips (31, 33, 64) have tooth formations arranged in a row with symmetrical teeth, the tooth flanks of which have the same size on each side and in that the tooth flanks are smaller than 1 mm, preferably smaller than 1/10 mm.

9. Light deflection system according to several of the preceding claims, in particular according to claim 8, characterised by in that the individual reflector strips (64, 65) are determined in their concave shape in such a way that a focusing zone (F1 and F2) is formed in each case which, when light is incident, lies parallel to the shadow line S between two slats near or in the region of the slat edges of an upper slat.

10. Light guiding system according to several of the preceding claims, characterised in that a reflector strip with a serrated upper side in an approximately horizontal cross-sectional position of the lamella body has an angle with an inclination to the interior of >0°<10°, in particular of >4°<7°, and in that a parallel lamella strip with a smooth surface has an angle with an inclination to the exterior A of >10°<25°, in particular >12°<22°.

11. Production of the reflector strips according to claim 8, characterised in that the reflector strips consist of a film, the tooth structure being applied to the foil by means of UV-curing lacquers and the tooth structure then being metallised.

12. Production of the light guiding system according to claim 1 or 7 by the co-extrusion process, wherein reflector strips (64, 65, 95, 96) are fed to the louvre body in the co-extrusion process and form a composite therewith, wherein the reflector strips consist of a thin, metallic material or of plastic films or paper.
